(19) United States
(12) Patent Application Publication
(10) Pub. No.: US 2026/0365866 A1
(43) Pub. Date: Nov. 19, 2026

(54) Ink Jet Ink Composition And Recording Method

(71) Applicant: SEIKO EPSON CORPORATION, Tokyo (JP)

(72) Inventors: Tetsuya AOYAMA, Shiojiri (JP); Kenta KIKUCHI, Suwa (JP); Tetsuya ITO, Matsumoto (JP)

(21) Appl. No.: 19/576,542

(22) Filed: Mar. 24, 2026

(30) Foreign Application Priority Data
Mar. 25, 2025 (JP) 2025-049676

(51) Int. Cl. C09D 11/322; C09D 11/326

(52) U.S. Cl. CPC C09D 11/322; C09D 11/326

(57) ABSTRACT

Provided is an ink jet ink composition containing a pigment, and a zwitterionic compound, wherein the pigment includes a resin-dispersed pigment dispersed by a crosslinked resin, and the ink jet ink composition is a water-based ink.

The present application is based on, and claims priority from JP Application Serial Number 2025-049676, filed Mar. 25, 2025, the disclosure of which is hereby incorporated by reference herein in its entirety.

### BACKGROUND

### 1. Technical Field

The present disclosure relates to an ink jet ink composition and a recording method.

### 2. Related Art

Ink jet recording methods can record high-definition images using relatively simple apparatuses, and achieve rapid development in various fields. For example, International Publication No. 2004/92285 discloses a pigment dispersion liquid containing at least a pigment, an aqueous medium, a copolymer resin of a hydrophobic monomer and a hydrophilic monomer, and a urethane resin.

It is desired to make the storage stability and the like more excellent in an ink jet ink in which a resin-dispersed pigment dispersed by a crosslinked resin is used for the ink.

### SUMMARY

An ink jet ink composition of the present disclosure contains a pigment, and a zwitterionic compound, wherein the pigment includes a resin-dispersed pigment dispersed by a crosslinked resin, and the ink jet ink composition is a water-based ink.

A recording method of the present disclosure includes an ejecting step of ejecting the ink jet ink composition onto a recording medium by an ink jet method.

### BRIEF DESCRIPTION OF THE DRAWINGS

FIG. 1 is a diagram showing an example of a recording apparatus used in the present embodiment.

FIG. 2 is Table 1 showing the compositions of respective compositions used in Examples and the evaluation results thereof.

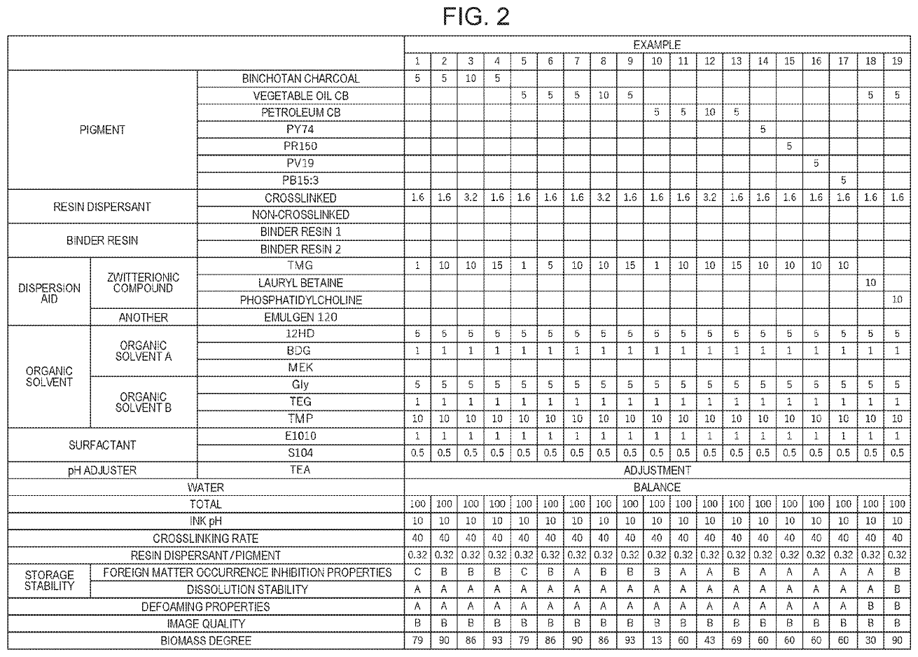

FIG. 3 is Table 2 showing the compositions of respective compositions used in Examples and Comparative Examples and the evaluation results thereof.

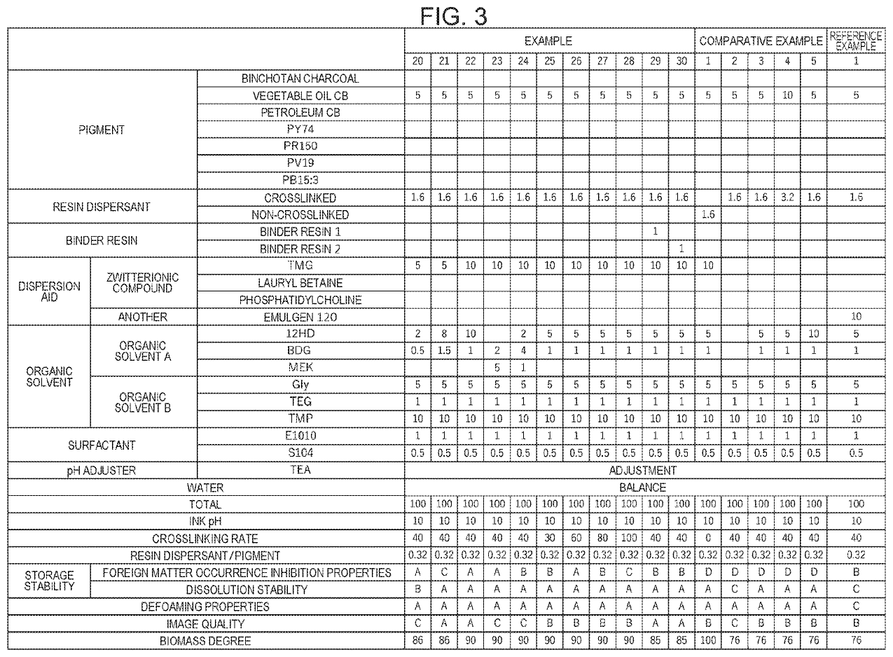

### DESCRIPTION OF EMBODIMENTS

The present embodiment will be described below in detail with reference to the drawings as needed, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

The ink jet ink composition (hereinafter also referred to as “ink composition”) of the present embodiment contains a pigment and a zwitterionic compound, in which the pigment includes a resin-dispersed pigment dispersed by a crosslinked resin, and is a water-based ink.

In ink jet inks, a resin-dispersed pigment dispersed by a resin dispersant has repulsive force due to the steric hindrance of the resin dispersant, and the dispersion stability can be improved. In addition, the fixability can also be improved by the resin dispersant.

On the other hand, a permeating solvent is used in order to increase the wetting and spreading properties and the permeability of the ink to a recording medium and to improve image quality. The permeating solvent is a component that can increase the wetting and spreading and the permeability of the ink to the recording medium. As the permeating solvent, an organic solvent or a surfactant is mainly used, and especially an organic solvent is excellent as the permeating solvent. In particular, an organic solvent having high hydrophobicity has high permeability. However, such a permeating solvent, especially an organic solvent, on the other hand, tends to dissolve or swell the resin. Therefore, the resin dispersant used in the resin-dispersed pigment is peeled off from the pigment, the dispersion stability of the resin-dispersed pigment may deteriorate, and the storage stability may decrease.

Given these circumstances, it is considered to use a resin-dispersed pigment dispersed by a resin dispersant having a crosslinked structure (hereinafter also referred to as “crosslinked resin-dispersed pigment”). In the crosslinked resin-dispersed pigment, adhesion and adsorption to the pigment by the resin dispersant are easily stabilized, and thus the storage stability is easily improved. However, in the crosslinked resin-dispersed pigment, a reagent and the like used for a crosslinking reaction, such as a crosslinking agent, used in the production process may remain as impurities in the ink. When these impurities become foreign matter, or when these impurities act on the pigment or a binder resin to make them foreign matter, the storage stability may decrease. In particular, when the ink dries, the concentration of the permeating solvent and these impurities increases, and in addition, the organic solvent and the like are difficult to evaporate, and thus the concentration of the organic solvent and the like also increases. As a result, the pigment or the binder resin is more likely to become foreign matter, and the storage stability may further decrease.

The ink jet composition in the present embodiment contains a zwitterionic compound in addition to the crosslinked resin-dispersed pigment. In the crosslinked resin-dispersed pigment, adhesion and adsorption to the pigment by the resin dispersant are easily stabilized, and thus the storage stability is easily improved. On the other hand, the crosslinked resin-dispersed pigment may contain a reagent and the like used for a crosslinking reaction, such as a crosslinking agent, as impurities. However, the zwitterionic compound can emulsify the foreign matter to inhibit the pigment and the binder resin from becoming foreign matter, and improve the storage stability. In addition, since the zwitterionic compound has high affinity for both a hydrophilic substance and a hydrophobic substance, also has a function as a dispersion aid and a moisturizer, and can thus also improve the dispersibility of the pigment and inhibit the drying of the ink.

If the ink dries, the amount of the solvent changes, and the pH of the ink may greatly change. For example, a general emulsifier such as polyoxyethylene ether may decrease in a function as an emulsifier when the pH changes. In this regard, since the zwitterionic compound can exhibit a function as an emulsifier in a wide pH range, becoming foreign matter can be inhibited even in drying, and thus the storage stability is improved. However, the action mechanism is not limited thereto.

In the ink composition in the present embodiment, the biomass degree of a dry solid content is preferably 10% or more. Such an ink composition tends to be able to further reduce the amount of CO₂ emissions due to petroleum-derived components. From such a viewpoint, the biomass degree is more preferably 10% or more, 20% or more, 40% or more, 50% or more, 60% or more, 70% or more, 80% or more, 90% or more, or 95% or more. The upper limit is 100% or less.

The biomass degree is an index indicating the ratio of bio-derived raw materials to the total amount of raw materials of a certain material, and the biomass degree of an ink composition is calculated by obtaining the sum of values obtained by multiplying the biomass degree of each material by the content of each material with respect to the total amount of the dry solid content of the ink composition. The biomass degree of each material of the ink composition is based on ASTM D6866, and is calculated based on the concentration of ¹⁴C, which is an isotope of ¹²C. The concentration of ¹⁴C is measured by accelerator mass spectrometry (the AMS method). Note that in the present specification, organisms are living organisms such as animals, plants, and microorganisms, and are not derived from underground resources such as petroleum.

Hereinafter, each component of the ink composition of the present embodiment will be described in detail.

### 1.1. Pigment

### 1.1.1. Resin-Dispersed Pigment

The pigment can be classified according to its dispersion form, and examples of such a classification include a self-dispersible pigment, which is dispersed by itself without using a dispersant, and a dispersant-dispersed pigment, which is dispersed by a dispersant. A resin-dispersed pigment uses a resin as a dispersant. The dispersant that is a resin is a resin dispersant.

The pigment in the present embodiment includes a crosslinked resin-dispersed pigment in which a crosslinked resin is used as a dispersant. When the pigment surface is at least partially covered with the crosslinked resin, the resin is less likely to be separated from the pigment surface, for example, even in the presence of a highly hydrophobic organic solvent. Therefore, the storage stability is improved. In addition, since a highly hydrophobic organic solvent or the like can be used in combination, an ink having improved image quality is easily obtained.

As the crosslinked resin used as the dispersant, for example, an acrylic-based resin, a urethane-based resin, a maleic acid-based resin, a polyether-based resin, a polyester-based resin, or the like can be used, and an acrylic-based resin is particularly preferable. The acrylic-based resin is a resin obtained by polymerizing at least an acrylic-based monomer, and may be, for example, a copolymer resin of the acrylic-based monomer and another polymerizable monomer, such as a styrene acrylic resin.

The method for producing the crosslinked resin-dispersed pigment in the present embodiment is not particularly limited, and examples thereof include a method of directly reacting a resin dispersant having a crosslinked structure with a pigment, and a method of dispersing a pigment with a resin and then crosslinking the resin, which includes a step of polymerizing a resin having a reactive functional group such as a carboxy group or a hydroxy group, a step of mixing the resin and the pigment, and a step of crosslinking the reactive functional group. The method of dispersing a pigment with a resin and then crosslinking the resin is preferable because the dispersion stability of the pigment is particularly excellent.

Examples of the monomer constituting the resin having a reactive functional group include a monomer having an ionic group and a hydrophobic monomer. The resin having a reactive functional group may be a copolymer of a monomer having an ionic group or a hydrophobic monomer.

The monomer having an ionic group is not particularly limited, and examples thereof include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate; unsaturated tertiary amine-containing monomers such as N, N-dimethylaminoethyl (meth)acrylate, N, N-dimethylaminopropyl (meth)acrylate, N, N-diethylaminoethyl (meth)acrylate, N, N-dimethylaminopropyl (meth)acrylamide, N, N-dimethylallylamine, vinylpyrrolidone, 2-vinylpyridine, 4-vinylpyridine, 2-methyl-6-vinylpyridine, and 5-ethyl-2-vinylpyridine; and unsaturated ammonium salt-containing monomers such as quaternized N, N-dimethylaminoethyl (meth)acrylate, quaternized N, N-diethylaminoethyl (meth)acrylate, and quaternized N, N-dimethylaminopropyl (meth)acrylate.

The content of the constituent unit derived from the monomer having an ionic group is preferably 1 to 80% by mass, 10 to 50% by mass, 20 to 40% by mass, or 25 to 35% by mass with respect to the total amount of the resin dispersant. When the content of the constituent unit derived from the monomer having an ionic group is within the above range, the storage stability tends to be further improved.

In addition, the hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl (meth)acrylate, cyclohexyl (meth)acrylate, 2-ethylhexyl (meth)acrylate, octyl (meth)acrylate, decyl (meth)acrylate, dodecyl (meth)acrylate, stearyl (meth)acrylate, isopropyl (meth)acrylate, isobutyl (meth)acrylate, tert-butyl (meth)acrylate, isoamyl (meth)acrylate, isooctyl (meth)acrylate, isodecyl (meth)acrylate, isododecyl (meth)acrylate, and isostearyl (meth)acrylate; and aromatic group-containing monomers such as styrene, α-methylstyrene, 2-methylstyrene, vinyltoluene, divinylbenzene, chlorostyrene, phenyl (meth)acrylate, benzyl (meth)acrylate, and phenoxyethyl (meth)acrylate.

The content of the constituent unit derived from the hydrophobic monomer is preferably 30 to 99% by mass, 50 to 90% by mass, 60 to 80% by mass, or 65 to 75% by mass with respect to the total amount of the resin dispersant. When the content of the constituent unit derived from the hydrophobic monomer is within the above range, the storage stability tends to be further improved.

The polymerization initiator used for polymerizing the resin having a reactive functional group is not particularly limited, and examples thereof include 2,2′-azobis(2-amidinopropane) dibasic acid, 4,4′-azobis(4-cyanovaleric acid), 2,2′-azobis[2-(5-methyl-2-imidazolin-2-yl)propane] dihydrochloride, 2,2′-azobis[2-(2-imidazolin-2-yl)propane] dihydrochloride, 2,2′-azobis[2-(2-imidazolin-2-yl)propane] disulfate dihydrate, 2,2′-azobis[2-(3,4,5,6-tetrahydropyrimidin-2-yl)propane] dihydrochloride, 2,2′-azobis[2-(1-(2-hydroxyethyl)-2-yl)propane] dihydrochloride, 2,2′-azobis(2-methylpropionamidine) dihydrochloride, and 2,2′-azobis[N-(2-carboxyethyl)-2-methylpropionamide].

The polymerization chain transfer agent used for polymerizing the resin having a reactive functional group is not particularly limited, and examples thereof include polymerization chain transfer agents having an anionic group, such as 2-mercaptopropionic acid, 3-mercaptopropionic acid, mercaptosuccinic acid, thioglycolic acid, thiolactic acid, 4,4′-dithiobutyric acid, 3,3′-dithiopropionic acid, and dithioglycolic acid; polymerization chain transfer agents having a cationic group, such as 1-amino-2-methyl-2-propanethiol, 2-aminoethanethiol, 2-diethylaminoethanethiol, 2-dimethylaminoethanethiol, 4-aminothiophenol, dithiodianiline, 3,4,5,6-tetrahydro-2-pyrimidinethiol, and 2-mercaptothiazoline; and polymerization chain transfer agents having an amphoteric ionic group, such as DL-penicillamine, N-(2-mercaptopropionyl)glycine, DL-cysteine, DL-homocysteine, cystamine, DL-cystine, and like thiol group-containing amino acids, as well as derivatives thereof.

Examples of the crosslinking agent include those capable of reacting with the reactive functional group of the resin to form an ester bond, a thioester bond, an amide bond, an amino bond, an ether bond, a thioether bond, a carbonyl bond, a thiocarbonyl bond, a sulfonyl bond, or the like.

Such a crosslinking agent is not particularly limited, and examples thereof include compounds having two or more functional groups such as an epoxy group, an isocyanate group, an aziridino group, an amino group, and an oxazoline group in the molecule. Among these, a compound having two or more functional groups of one or more kinds selected from the group consisting of an epoxy group, an oxazoline group, and an isocyanate group in the molecule is preferable. By using such a compound, the storage stability tends to be improved.

Such a crosslinking agent is not particularly limited, and examples thereof include a polyfunctional epoxy compound having two or more epoxy groups in the molecule. The polyfunctional epoxy compound is not particularly limited, and examples thereof include polypropylene glycol diglycidyl ether, glycerol polyglycidyl ether, polyglycerol polyglycidyl ether, trimethylolpropane polyglycidyl ether, sorbitol polyglycidyl ether, pentaerythritol polyglycidyl ether, resorcinol diglycidyl ether, neopentyl glycol diglycidyl ether, and hydrogenated bisphenol A diglycidyl ether.

The crosslinking rate is preferably 20 to 100 mol %, 25 to 90 mol %, 32 to 80 mol %, 35 to 75 mol %, 40 to 70 mol %, 45 to 65 mol %, or 50 to 60 mol % with respect to the total amount of the reactive functional group of the resin. When the amount of the crosslinking agent added is within the above range, there is a tendency that the foreign matter occurrence inhibition, the image quality, the redispersibility, the clogging recoverability, the storage stability, and the like are further improved. Note that the crosslinking rate is a ratio (mol %) of the number of moles of the crosslinkable functional group of the crosslinking agent to the number of moles of the reactive functional group of the resin dispersant.

The pigment dispersed by the crosslinked resin dispersant is not particularly limited, and examples of the pigment include inorganic pigments such as carbon black and titanium white; and organic pigments. In particular, the ink composition in the present embodiment preferably contains organic pigments and/or carbon black. By using these pigments, the storage stability tends to be further improved.

Examples of the organic pigments include azo pigments such as an azo lake pigment, an insoluble monoazo pigment, an insoluble disazo pigment, a condensed azo pigment, and a chelate azo pigment; polycyclic pigments such as a phthalocyanine pigment, a quinacridone pigment, a perylene pigment, a perinone pigment, an anthraquinone pigment, a dioxazine pigment, a thioindigo pigment, an isoindolinone pigment, and a quinophthalone pigment; dye chelates such as a basic dye-type chelate and an acid dye-type chelate; and nitro pigments and nitroso pigments.

Examples of the inorganic pigments include titanium oxide, iron oxide yellow, iron oxide brown, chromium oxide, ultramarine, Prussian blue, molybdenum red, iron oxide black, lead yellow, composite oxide pigments, and carbon black.

Examples of a white pigment include C.I. Pigment White 6, 18, and 21.

Examples of a yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of a magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of a cyan pigment include C.I. Pigment Blue 1, 2, 3, 15, 15:1, 15:2, 15:3, 15:34, 15:4, 16, 18, 22, 25, 60, 65, and 66, and C.I. Vat blue 4 and 60.

Examples of pigments other than black, white, yellow, magenta, and cyan include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

Examples of a black pigment include C.I. (Colour Index Generic Name) Pigment Black 1, 7, and 11. Examples of commercially available products of the carbon black used as the black pigment include No. 2300, No. 900, MCF 88, No. 33, No. 40, No. 45, No. 52, MA 7, MA 8, MA 100, and No. 2200B (trade names, manufactured by Mitsubishi Chemical Corporation); Raven 5750, 5250, 5000, 3500, 1255, and 700 (trade names, manufactured by Columbia Carbon Inc.); Regal 400R, 330R, and 660R, Mogul L, Monarch 700, 800, 880, 900,1000, 1100, 1300, and 1400 (trade names, manufactured by Cabot Corporation); and Color Black FW1, FW2, FW2V, FW18, FW200, S150, S160, and S170, Printex 35, U, V, and 140U, Special Black 6, 5, 4A, and 4 (trade names, manufactured by Degussa Corporation). The carbon black produced by a known method such as a contact method, a furnace method, or a thermal method may be used.

The content of the pigment not including the resin dispersant is preferably 0.1 to 15% by mass, 1 to 12% by mass, 2 to 9% by mass, or 3 to 7% by mass with respect to the total amount of the ink composition. When the content of the pigment is within the above range, the storage stability tends to be further improved.

The content of the resin dispersant is preferably 0.1 to 10% by mass, 0.3 to 5% by mass, 0.5 to 4% by mass, or 1 to 2% by mass with respect to the total amount of the ink composition. When the content of the resin dispersant is within the above range, the storage stability tends to be further improved.

The mass ratio of the resin dispersant to the pigment is preferably 0.05 to 0.8, 0.1 to 0.7, 0.2 to 0.5, or 0.25 to 0.4. When the mass ratio of the resin dispersant to the pigment is within the above range, the storage stability tends to be further improved.

### 1.1.1.1. Bio-Derived CB

The pigment of the present embodiment preferably includes a bio-derived carbon black (hereinafter also referred to as “bio-derived CB”). Using the bio-derived CB derived from natural products can make an ink that reduces petroleum-derived components, reduces the amount of CO₂ emissions due to petroleum-derived components, and is environmentally friendly.

The bio-derived CB is a carbon black made from organisms. It is a carbon black that is a carbonized product obtained by carbonizing raw materials derived from organisms by heating or the like. Since it is a carbon black derived from organisms, it can reduce petroleum-derived components, and can contribute to a reduction in CO₂ emissions due to petroleum-derived components. Since the bio-derived CB is derived from organisms as raw materials and may contain a large number of impurities, the effect of the present embodiment is remarkable.

The bio-derived CB is not particularly limited, and examples thereof include a biological oil-derived carbon black (hereinafter also referred to as “biological oil-derived CB”) and a biochar-derived carbon black (hereinafter also referred to as “biochar-derived CB”).

The content of the bio-derived CB is preferably 0.1 to 15% by mass, 0.5 to 12% by mass, 2 to 9% by mass, 3 to 8% by mass, or 4 to 7% by mass with respect to the total amount of the ink composition. When the content of the bio-derived CB is within the above range, the storage stability tends to be further improved.

### 1.1.1.1.1. Biological Oil-Derived CB

The biological oil-derived CB is a carbon black that is a carbonized product obtained by carbonizing a biological oil such as oil secreted by organisms or oil obtained by processing materials obtained from organisms into oil by heating or the like. The biological oil-derived CB is similar to carbon black made from petroleum in production method, easily controls impurities contained therein and controls the structure of the carbon black, and is relatively easy to uniformly produce, which is preferable. For this reason, in the bio-derived CB, the pigment is easily stably dispersed, and excellent storage stability, ejection stability, and the like are easily obtained, which is preferable.

The biological oil, which is a raw material of the biological oil-derived CB, is not particularly limited, and examples thereof include animal oils, vegetable oils, and microbial oils. Examples of the animal oils bovine oil, horse oil, and fish oil. Examples of the microbial oils include algae oil.

Examples of the vegetable oils include vegetable seed oil, tall oil, wood tar, and modified products thereof such as hydrogenated products and derivatives. The modified products are products obtained by modifying vegetable oils as long as the effect of the present embodiment is obtained. Specific examples thereof include avocado oil, linseed oil, almond oil, fennel oil, perilla oil, olive oil, orange oil, orange roughy oil, cocoa butter, chamomile oil, carrot oil, cucumber oil, apricot kernel oil, kukui nut oil, walnut oil, wheat germ oil, sesame oil, rice oil, rice bran oil, sasanqua oil, safflower oil, salad oil, shea butter, soybean oil, tea oil, evening primrose oil, camellia oil, corn oil, rapeseed oil, persic oil, safflower oil, castor oil, sunflower oil, grape seed oil, hazelnut oil, macadamia nut oil, cottonseed oil, meadowfoam oil, peanut oil, rosehip oil, turtle oil, palm oil, palm kernel oil, Japan wax, coconut oil, wood tar oil, tall oil, and wood-tar creosote, and modified products such as hydrogenated products thereof and derivatives thereof. In the biological oil-derived CB, a vegetable oil-derived carbon black made from a vegetable oil is preferable in that a relatively homogeneous vegetable oil as a raw material is easily available in a relatively large amount, that the vegetable oil as a raw material is easy to handle and easy to preserve, and that the dispersion stability as the pigment is particularly excellent.

The method for producing the biological oil-derived CB is not particularly limited, and for example, a known method such as a furnace method, a channel method, or a lamp method is used. It is also possible to control the structure and primary particles of carbon black by adding an alkaline agent such as potassium hydroxide or sodium hydroxide in addition to conditions such as the heating temperature and sample amount in the process of preparing a raw material for a biological oil or a modified product thereof.

The content of the biological oil-derived CB is preferably 0.1 to 15% by mass, 0.5 to 12% by mass, 2 to 9% by mass, 3 to 8% by mass, or 4 to 7% by mass with respect to the total amount of the ink composition. When the content of the biological oil-derived CB is within the above range, the storage stability tends to be further improved.

### 1.1.1.1.2. Biochar-Derived CB

The biochar-derived CB is a carbon black that is a carbonized product obtained by carbonizing a bio-derived material such as a solid that is not a biological oil by heating or the like. The biochar-derived CB is not particularly limited, and examples thereof include vegetable coals such as binchotan charcoal and bamboo charcoal. These biochar-derived CBs contain a particularly large number of impurities such as metal ions, and it is also difficult to control the particle size and the structure, and pH changes and the ejection stability when made into ink are particularly problematic. Therefore, the effect of improving the storage stability and the ejection stability due to the function of the betaine as a moisturizer and a dispersion aid in the present embodiment is remarkable.

The content of the biochar-derived CB is preferably 0.1 to 15% by mass, 0.5 to 12% by mass, 2 to 9% by mass, 3 to 8% by mass, or 4 to 7% by mass with respect to the total amount of the ink composition. When the content of the biochar-derived CB is within the above range, the storage stability tends to be further improved.

### 1.2. Zwitterionic Compound

The ink composition of the present embodiment contains a zwitterionic compound. The zwitterionic compound has high affinity for both a hydrophilic substance and a hydrophobic substance, functions as a dispersion aid and a moisturizer, improves the dispersion stability of the pigment, and can inhibit the drying of the ink. In addition, the crosslinked resin-dispersed pigment may contain a reagent and the like used for a crosslinking reaction, such as a crosslinking agent, as impurities in the ink. However, the zwitterionic compound can emulsify the foreign matter to inhibit the pigment and the binder resin from becoming foreign matter, and improve the storage stability. In addition, even if the ink dries and the pH changes, the zwitterionic compound can exhibit a function as an emulsifier in a wide pH range to inhibit becoming foreign matter. Emulsifiers other than the zwitterionic compound are also contemplated, but tend to be likely to foam and lower the cloud point of the ink. In this regard, since the zwitterionic compound is less likely to foam and can provide an ink having excellent defoaming properties, ejection failure due to foaming can also be reduced. In addition, since the zwitterionic compound is also less likely to lower the cloud point of the ink, the dissolution stability of the ink is also improved.

The zwitterionic compound is not particularly limited so long as it is a compound having stable positive and negative charges in the molecule. Examples of the partial structure of the zwitterionic compound having a positive charge include an amino group including a quaternary amino group. Examples of the partial structure having a negative charge include a carboxy group, a phosphoric acid group, and a sulfo group. Examples of the zwitterionic compound include compounds having an amino group and a carboxy group, an amino group and a phosphoric acid group, and an amino group and a sulfo group in the molecule.

The zwitterionic compound is preferably an amino acid, sulfamic acid, a betaine, zwitterionic phospholipids such as phosphatidylcholine, phosphatidylethanolamine, and sphingomyelin, and psilocybin. By using such a compound, the storage stability tends to be further improved.

The zwitterionic compound may be a betaine. The betaine means a compound having a positive charge and a negative charge at positions that are not adjacent to each other in the same molecule, in which hydrogen that can be dissociated is not bonded to an atom having the positive charge, and constitutes an intramolecular salt and has no charge as a whole molecule. The betaine has particularly excellent moisture-retaining properties, and tends to be able to further inhibit the drying of the ink. In addition, since it is relatively easy to produce the betaine from a bio-derived raw material or to obtain a commercially available product produced from a bio-derived raw material, there is a tendency that the biomass degree of the entire ink composition can be further improved. The betaine is not particularly limited, and examples thereof include trimethylglycine, γ-butyrobetaine, homarine, trigonelline, carnitine, homoserine betaine, valine betaine, lysine betaine, ornithine betaine, alanine betaine, lauryl betaine, stachydrine, and betaine glutamate. Among these, those in which the positively charged moiety is a quaternary ammonium cation are preferred. Among these, trialkylglycine is preferable, and trialkylglycine in which each alkyl group is an alkyl group having three or less carbon atoms is more preferable. In particular, trimethylglycine is preferable. Thus, the storage stability tends to be further improved. One kind of these may be used alone, two or more kinds thereof may be used in combination.

The number of carbon atoms constituting the betaine is preferably 4 to 20, 4 to 12, 4 to 7, or 4 to 6. When the number of carbon atoms of the betaine is within the above range, the storage stability and the defoaming properties tend to be further improved.

The content of the zwitterionic compound is preferably 0.1 to 20% by mass, 1 to 15% by mass, 3 to 13% by mass, or 7 to 11% by mass with respect to the total amount of the ink composition. When the content of the zwitterionic compound is within the above range, the storage stability and the defoaming properties tend to be further improved. In addition, adverse effects due to an excess of the zwitterionic compound can be inhibited.

The content of the zwitterionic compound is preferably 0.5 to 10 parts by mass, 1 to 9 parts by mass, 2 to 8 parts by mass, or 3 to 7 parts by mass with respect to 1 part by mass of the resin dispersant. When the content of the zwitterionic compound is within the above range, the storage stability and the defoaming properties tend to be further improved.

Further, the content of the zwitterionic compound is preferably 0.1 to 5 parts by mass, 0.2 to 3 parts by mass, 0.5 to 2.5 parts by mass, or 1 to 2 parts by mass with respect to 1 part by mass of the pigment. When the content of the zwitterionic compound is within the above range, the storage stability and the defoaming properties tend to be further improved.

### 1.3. Organic Solvent

The ink composition in the present embodiment may contain an organic solvent. In particular, it is a water-soluble organic solvent suitable for a water-based ink. The organic solvent can increase the wetting and spreading properties, the permeability, and the moisture-retaining properties of the ink. In particular, the ink composition in the present embodiment preferably contains an organic solvent A with an octanol-water partition coefficient logP_{ow} value of 0 to 1. Such an organic solvent A has particularly high wetting and spreading properties and permeability of the ink, and thus the ink tends to have more excellent image quality. On the other hand, since the force for dissolving and swelling the resin tends to be strong, the effect of the present embodiment becomes remarkable.

The ink composition in the present embodiment may contain an organic solvent B with a logP_{ow} value other than 0 to 1 as needed. The organic solvent B is an organic solvent other than the organic solvent A.

The logP_{ow} value of the organic solvent A is preferably 0.1 to 1, 0.2 to 0.9, 0.3 to 0.8, 0.4 to 0.7, or 0.5 to 0.6. When the logP_{ow} value is equal to or greater than a predetermined value, the ink tends to have higher wetting and spreading properties and permeability, and to have more excellent image quality. When the logP_{ow} value is equal to or less than a predetermined value, the compatibility with water tends to be more excellent. Therefore, when the logP_{ow} value is within the above range, the storage stability of the ink composition and the image quality tend to be further improved.

In the present embodiment, the octanol-water partition coefficient logP_{ow} value refers to a value defined by OECD Test Guideline 107. The octanol-water partition coefficient is expressed as logP_{ow}, logK_{ow}, or the like. A higher logP_{ow} value indicates higher hydrophobicity, and a lower logP_{ow} value indicates higher hydrophilicity. The octanol-water partition coefficient logP_{ow} value is also referred to as an octanol-water partition coefficient, a logP_{ow} value, or the like.

The logP_{ow} value of a compound can be determined by various methods, and, for example, it can be determined by measurement in accordance with the measurement method specified in JIS Z 7260-117. It can also be calculated using Hansen Solubility Parameter Software (HSPIP).

The organic solvents A and B are not particularly limited, and examples thereof include monoalcohols, polyols, ethers, and amides. Examples of the amides include lactam compounds and the other amides.

Examples of the monoalcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxyethanol, benzyl alcohol, and phenoxypropanol.

The polyols are organic solvents having two or more hydroxy groups. Examples thereof include glycols having two hydroxy groups and polyols having three or more hydroxy groups. Examples of the polyols having three or more hydroxy groups include glycerin and trimethylolpropane.

Examples of the glycols include alkanediols and condensates having a structure in which hydroxy groups between molecules of alkanediols are condensed. The alkanediols are compounds with the hydrogen atoms of alkanes replaced with two hydroxy groups. Examples of the condensates having a structure in which hydroxy groups between molecules of alkanediols are condensed include condensates having a structure in which hydroxy groups between molecules of diols of alkanes having 2 to 4 carbon atoms Are Condensed.

Examples of the glycols include alkane diols such as ethylene glycol, propylene glycol, 1,2-propanediol, 1,2-butanediol, 1,2-pentanediol, 1,2-hexanediol, 1,2-octanediol, 1,3-propanediol, 1,4-butanediol, and 1,6-hexanediol; and condensates having a structure in which hydroxy groups between molecules of alkanediols are condensed, such as tetramethylene glycol, hexamethylene glycol, diethylene glycol, triethylene glycol, tetraethylene glycol, polyethylene glycol, dipropylene glycol, tripropylene glycol, polypropylene glycol, and (poly)tetramethylene glycol.

The ethers are not particularly limited, and examples thereof include alkyl ethers and glycol ethers. Examples of the alkyl ethers include dimethyl ether, methyl ethyl ether, diethyl ether, isopropyl methyl ether, and isopropyl ethyl ether.

Examples of the glycol ethers include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the ketones include acetone, methyl ethyl ketone, and diethyl ketone. Examples of the amides include lactam compounds and the other amides. Examples of the lactam compounds include 2-pyrrolidone, N-methyl-2-pyrrolidone, N-ethyl-2-pyrrolidone, and N-hydroxyethylpyrrolidone (HEP).

Among the above organic solvents, the organic solvent A is one having an octanol-water partition coefficient logP_{ow} value of 0 to 1. Examples of such an organic solvent A include any one of monoalcohols, alkanediols, ethers, and ketones, and an organic solvent having an octanol-water partition coefficient of 0 to 1 is easily obtained and thus preferable. The alkanediols are particularly preferably 1,2-alkanediols. Alkanediols, glycol ethers, and ketones are preferable from the viewpoint of excellent image quality and capability of inhibiting a decrease in the storage stability; alkanediols and glycol ethers are more preferable, and alkanediols are particularly preferable.

Specific examples thereof include isopropyl methyl ether, diethylene glycol monobutyl ether, triethylene glycol monobutyl ether, 1,2-hexanediol, methyl ethyl ketone, isopropyl alcohol, and methyl ethyl ketone.

The content of the organic solvent A is preferably 1 to 15% by mass, 2 to 11% by mass, 4 to 9% by mass, or 5 to 7% by mass with respect to the total amount of the ink composition. When the content of the organic solvent A is within the above range, the storage stability and the image quality tend to be further improved.

The organic solvent B may be various organic solvents described above, but have an octanol-water partition coefficient logP_{ow} value of less than 0 or more than 1. In particular, organic solvents having a logP_{ow} value of less than 0 are preferable. The organic solvent B improves moisture-retaining properties in particular.

The content of the organic solvent B is preferably 0.5 to 20% by mass, 10 to 19% by mass, 12 to 18% by mass, or 14 to 17% by mass with respect to the total amount of the ink composition. When the content of the organic solvent B is within the above range, the storage stability and the image quality tend to be further improved.

The total content of the organic solvent including the organic solvents A and B is preferably 5 to 45% by mass, 10 to 40% by mass, 15 to 35% by mass, 17 to 30% by mass, or 19 to 25% by mass with respect to the total amount of the ink composition. When the content of the organic solvent is within the above range, the storage stability and the image quality tend to be further improved.

### 1.4. Surfactant

The ink composition in the present embodiment may contain a surfactant. The surfactant can increase the wetting and spreading properties, the permeability, and the moisture-retaining properties of the ink. The surfactant is not particularly limited, and examples thereof include a silicone-based surfactant, an acetylene glycol-based surfactant, and a fluorine-based surfactant. One kind of these may be used alone, two or more kinds thereof may be used in combination.

The acetylene glycol-based surfactant is not particularly limited, and examples thereof include 2,4,7,9-tetramethyl-5-decyne-4,7-diol and an alkylene oxide adduct of 2,4,7,9-tetramethyl-5-decyne-4,7-diol. Examples of commercially available products of acetylene glycol-based surfactants include Olfine E1010, EXP4200, EXP4300, Surfynol SE, Surfynol 440, Surfynol 104, and Surfynol 465 (trade name, manufactured by Nissin Chemical Industry Co., Ltd.).

The fluorine-based surfactant is not particularly limited, and examples thereof include perfluoroalkyl sulfonates, perfluoroalkyl carboxylates, perfluoroalkyl phosphates, perfluoroalkyl ethylene oxide adducts, perfluoroalkyl betaines, and perfluoroalkylamine oxide compounds.

The silicone-based surfactant is not particularly limited, and examples thereof include polysiloxane-based compounds and polyether modified organosiloxanes. Examples of commercially available products of silicone-based surfactants include BYK-306, BYK-307, BYK-333, BYK-341, BYK-345, BYK-346, BYK-348, BYK-UV3500, BYK-UV3510, BYK-UV3530, and BYK-UV3570 (trade name, manufactured by BYK).

The content of the surfactant is preferably 0.1 to 4% by mass, 0.3 to 3% by mass, 0.5 to 2.5% by mass, or 1 to 2% by mass with respect to the total amount of the ink composition. When the content of the surfactant is within the above range, the storage stability and the image quality tend to be further improved.

### 1.5. pH Adjuster

The ink jet ink composition in the present embodiment may contain a pH adjuster. The pH adjuster is not particularly limited, and examples thereof include inorganic acid such as sulfuric acid, hydrochloric acid, and nitric acid; inorganic bases such as lithium hydroxide, sodium hydroxide, potassium hydroxide, and ammonia; organic acids such as adipic acid, citric acid, and succinic acid; and organic bases such as triethanolamine, diethanolamine, monoethanolamine, triisopropanolamine, diisopropanolamine, and trishydroxymethylaminomethane. One kind of the pH adjuster may be used alone, or two or more kinds thereof may be used in combination.

### 1.6. Binder Resin

The ink composition in the present embodiment preferably contains a binder resin. The binder resin is a resin that enhances the fixation of the pigment to a recording medium, and when the ink composition contains the binder resin, the abrasion resistance and the like tend to be further improved. In addition, the filling of the ink is improved, and a reduction in white streaks is excellent. Note that in the present embodiment, the binder resin is distinguished from the resin dispersant. As the binder resin, a water-soluble resin, resin particles, or the like can be used. The resin particles are a resin contained in the ink in a dispersed form such as a resin emulsion. The water-soluble resin is more excellent in the storage stability and the like and is preferable.

The binder resin is not particularly limited, and examples thereof include an acrylic-based resin, a urethane-based resin, a polyester-based resin, a polyether-based resin, and a polyolefin-based resin. As these resins, commercially available products may be used, or those synthesized using a known method in the related art may be used. The acrylic-based resin is a resin obtained by polymerizing at least an acrylic-based monomer, and may be, for example, a copolymer resin of the acrylic-based monomer and another polymerizable monomer, such as a styrene acrylic resin.

The content of the binder resin is preferably 0.1 to 10% by mass, 0.3 to 5% by mass, 0.5 to 3% by mass, or 0.7 to 2% by mass with respect to the total amount of the ink composition. When the content of the binder resin is within the above range, the storage stability tends to be further improved.

### 1.7. Water

Water contained in the ink composition of the present embodiment is not particularly limited, and examples thereof include ion exchanged water, ultrafiltration water, reverse osmosis water, and distilled water.

The ink of the present embodiment is a water-based ink composition, and the water-based ink composition is an ink composition in which a solvent component contained in the ink mainly consists of at least water.

The content of water is preferably 40% by mass or more with respect to the total amount of the ink composition. The content is more preferably 40 to 99% by mass, 45 to 80% by mass, 50 to 70% by mass, 55 to 67% by mass, or 57 to 64% by mass. When the content of water is within the above range, the storage stability tends to be further improved.

### 1.8. Other Components

The ink composition of the present embodiment may contain other known components that can be used in ink compositions in the related art in addition to the above components. The other components are not particularly limited, and examples thereof include a dissolution aid, a viscosity modifier, an antioxidant, a preservative, a corrosion inhibitor, a chelating agent for capturing certain metal ions that affect dispersion, other additives, and organic solvents other than those described above. One kind of the other components may be used alone, or two or more kinds thereof may be used in combination.

### 2. Recording Medium

The recording medium used in the present embodiment is not particularly limited, and examples thereof include an absorbent recording medium, a low-absorbent recording medium, and a non-absorbent recording medium. The absorbent recording medium is preferable.

Examples of the absorbent recording medium include plain paper such as electrophotographic paper having high ink permeability, and ink jet dedicated paper including an ink absorbing layer formed of silica particles or alumina particles or an ink absorbing layer formed of a hydrophilic polymer such as polyvinyl alcohol or polyvinyl pyrrolidone.

Examples of the low-absorbent recording medium include art paper, coated paper, and cast paper, which have relatively low ink permeability and are used for general offset printing.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced by evaporation of these various metals, and plates of alloys such as stainless steel and brass; and recording media in which films of plastics such as polyvinyl chloride, polyethylene, polypropylene, polyethylene terephthalate (PET), polycarbonate, polystyrene, and polyurethane are bonded (applied) onto paper substrates.

### 3. Recording Apparatus

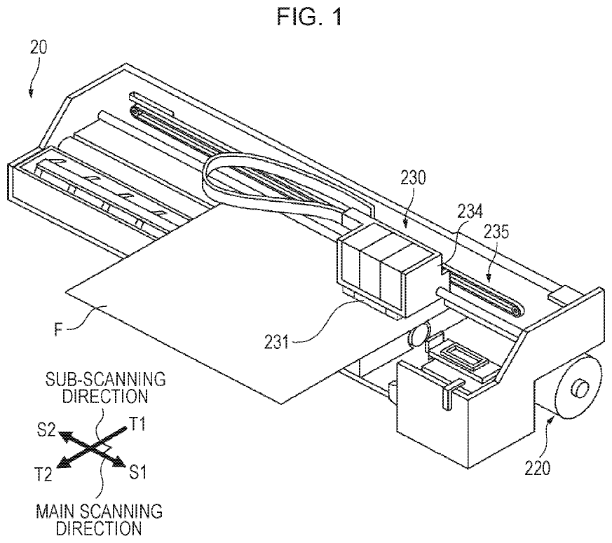

FIG. 1 shows a perspective view of a serial printer as an example of an ink jet apparatus used in the present embodiment. As shown in FIG. 1, a serial printer 20 includes a transport section 220 and a recording section 230. The transport section 220 transports a recording medium F fed to the serial printer to the recording section 230, and discharges the recording medium after recording to the outside of the serial printer. Specifically, the transport section 220 includes each feeding roller and transports the fed recording medium F in a sub-scanning direction T1.

The recording section 230 includes a carriage 234 on which an ink jet head 231 having nozzles that eject the ink composition onto the recording medium F sent from the transport section 220 is mounted, and a carriage movement mechanism 235 that moves the carriage 234 in main scanning directions S1 and S2 of the recording medium F.

In the case of the serial printer, a head having a length smaller than the width of the recording medium is provided as the ink jet head 231, the head moves, and recording is performed in a plurality of passes (multi-pass). In addition, in the serial printer, the head 231 is mounted on the carriage 234 that moves in a predetermined direction, and the ink composition is ejected onto the recording medium F by the head moving along with the movement of the carriage. As a result, recording is performed in two or more passes (multi-pass). Furthermore, the passes are also referred to as main scanning. Sub-scanning in which the recording medium is transported between the passes is performed. That is, the main scanning and the sub-scanning are alternately performed.

In addition, the ink jet apparatus of the present embodiment is not limited to the serial type printer and may be the above-described line type printer. The line type printer is a printer that performs recording on a recording medium in one scan using a line head, which is an ink jet head having a length equal to or larger than the recording width of the recording medium.

### 4. Ink Jet Recording Method

The ink jet recording method of the present embodiment includes an ink attaching step of ejecting the ink composition of the present embodiment from an ink jet head and attaching the ink composition to a recording medium, and may include other steps such as a transporting step of transporting the recording medium as needed.

### 4.1 Ink Attaching Step

In the ink attaching step, the ink composition of the present embodiment is ejected from the ink jet head and attached to a recording medium. More specifically, a pressure generating unit provided in the ink jet head is driven to eject, from the nozzle, an ink composition with which a pressure generating chamber of the ink jet head is filled.

Examples of the ink jet head that is used in the ink attaching step include a line head that carries out recording in a line method and a serial head that carries out recording in a serial method.

In the line method using the line head, for example, an ink jet head having a width equal to or larger than a recording width of the recording medium is fixed to the recording apparatus. Then, the recording medium is moved along a transporting direction, and ink droplets are ejected from the nozzles of the ink jet head in conjunction with this movement, whereby an image is recorded on the recording medium.

In the serial method using the serial head, for example, an ink jet head is mounted on a carriage that can move in a width direction of a recording medium. Then, the carriage is moved along the width direction of the recording medium, and ink droplets are ejected from the nozzles of the ink jet head in conjunction with this movement, whereby an image is recorded on the recording medium.

### 4.2. Transporting Step

The ink jet recording method of the present embodiment may include a transporting step. In the transport step, the recording medium is transported in a predetermined direction in the recording apparatus. More specifically, the recording medium is transported from a paper feeding section of the recording apparatus to a paper discharge section by using a transport roller or a transport belt, which is provided in the recording apparatus. In the transporting step, the ink composition ejected from the ink jet head is attached to the recording medium, and recorded matter is formed. The ink attaching step and the transporting step may be performed simultaneously or alternately.

### 5. Recorded Matter

The recorded matter of the present embodiment is obtained by attaching the ink composition described above on the recording medium. The recorded matter of the present embodiment using the ink composition described above can be recorded with an ink having excellent storage stability and ejection stability.

### EXAMPLES

Hereinafter, the present disclosure will be described in more detail with reference to Examples and Comparative Examples. The present disclosure is not limited by Examples below in any way.

### 1. Preparation of Ink Jet Ink Composition

Each component was put into a mixture tank so as to have the compositions shown in Tables 1 and 2, mixed and stirred, and further filtered through a membrane filter to obtain ink jet ink compositions of Examples and Comparative Examples. Unless otherwise specified, the numerical value of each component shown in each example in the tables indicates % by mass. Further, the contents (% by mass) of the components of the pigment, the resin dispersant, the binder resin, and the dispersion aid in Tables 1 and 2 represent solid content concentrations unless otherwise specified.

The materials shown in Tables 1 and 2 are as follows. Note that the pigment and the resin dispersant are mixed with the other materials after being made into a resin-dispersed pigment by the method described below. The content of the pH adjuster is adjusted such that the pH becomes the value in the table. The content of water is adjusted such that the total is 100% by mass.

### Pigment

Binchotan charcoal (manufactured by Kiriya Chemical Co. Ltd.)
Vegetable oil CB (vegetable oil-derived carbon black, trade name “PRINTEX Nature,” manufactured by Orion Engineered Carbons)
Petroleum CB (petroleum-derived carbon black, trade name “aqua black 162,” manufactured by Tokai Carbon Co., Ltd.)
PY74 (yellow pigment)
PR150 (magenta pigment)
PV19 (magenta pigment)
PB15:3 (cyan pigment)

### Resin Dispersant

Crosslinked resin dispersant and non-crosslinked resin dispersant (prepared by the following methods)

### Binder Resin

Binder resin 1 (acrylic-based resin, prepared by the following method)
Binder resin 2 (urethane-based resin, prepared by the following method)

### Dispersion Aid

TMG (trimethylglycine)
Lauryl betaine
Phosphatidylcholine
Emulgen 120 (trade name, polyoxyethylene lauryl ether, manufactured by Kao Corporation)

### Organic Solvent

### Organic Solvent A

1,2HD (1,2-hexanediol, logP_{ow}=0.57)
BDG (diethylene glycol monobutyl ether, logP_{ow}=0.56)
MEK (methyl ethyl ketone, logP_{ow}=0.29)
   Organic solvent B
Gly (glycerin)
TEG (triethylene glycol monobutyl ether)
TMP (trimethylolpropane)

### Surfactant

E1010 (trade name “Olfine E1010,” manufactured by Nissin Chemical Co., Ltd.)
S104 (trade name “Surfynol 104,” manufactured by Nissin Chemical Co., Ltd.)

### pH Adjuster

TEA (triethanolamine)

### Water

Ion exchanged water

### 1.1. Preparation of Crosslinked Resin-Dispersed Pigment Preparation of Resin Solution

A monomer mixed solution is prepared by mixing 31 parts by mass of acrylic acid and 69 parts by mass of styrene. In a reaction vessel, 5 parts by mass of methyl ethyl ketone, 0.25 part by mass of 3-mercaptopropionic acid (polymerization chain transfer agent), and 10% by mass of the monomer mixed solution (3.1 parts by mass of acrylic acid and 6.9 parts by mass of styrene) are mixed, and nitrogen gas replacement is sufficiently performed. Next, in a dropping funnel, a mixed solution of the remaining 90% by mass of the monomer mixed solution (28.9 parts by mass of acrylic acid and 62.1 parts by mass of styrene), 2.25 parts by mass of 3-mercaptopropionic acid, 75 parts by mass of methyl ethyl ketone, and 1.5 parts by mass of 4,4′-azobis(4-cyanovaleric acid) (azo-based radical polymerization initiator, manufactured by FUJIFILM Wako Pure Chemical Corporation) is prepared. Under a nitrogen atmosphere, the inside of the reaction vessel is heated to 77 °C with stirring, and the mixed solution in the dropping funnel is added dropwise over 5 hours. After the completion of dropwise addition, a solution prepared by dissolving 0.5 part by mass of 4,4′-azobis(4-cyanovaleric acid) in 5 parts by mass of methyl ethyl ketone is further added, and the mixture is further reacted at 77 °C for 2 hours to obtain a resin solution of a resin having a carboxy group.

### Preparation of Resin Dispersion

To 24 parts by mass of a resin obtained by drying the resin solution obtained above under reduced pressure, 200 parts by mass of ion exchanged water and 9.7 parts by mass of a 5 N aqueous sodium hydroxide solution (sodium hydroxide solid content: 16.9% by mass) are added, and neutralization is performed such that the ratio of the number of moles of sodium hydroxide to the number of moles of carboxy groups in the resin is 40% (the degree of neutralization: 40 mol %). The aqueous solution is heated at 90 °C for 5 hours with stirring at 150 rpm to obtain a resin dispersion.

### Preparation of Pigment Dispersion

The pigment listed in Table 1 is added to the obtained resin dispersion such that the mass ratio of the pigment to the previously added resin is the mass ratio listed in Table 1, and the mixture is stirred using a disper (Ultradisper, manufactured by Asada Ion Works Co., Ltd.) under the condition that the disper blade is rotated at 7,000 rpm at 20 °C for 60 minutes. The obtained mixture is subjected to a dispersion treatment for 10 passes with a microfluidizer (manufactured by Microfluidics Co., Ltd.) at a pressure of 200 MPa. The obtained dispersion liquid is filtered with a 25-mL capacity needleless syringe (manufactured by Terumo Corporation) equipped with a 5-μm filter (acetylcellulose membrane, outer diameter: 2.5 cm, manufactured by FUJIFILM Corporation) to remove coarse particles. Ion exchanged water is then added so as to give a solid content concentration of 22% by mass to obtain a pigment dispersion.

### Crosslinking of Resin

The pigment dispersion obtained above in an amount of 100 parts by mass is put into a glass bottle with a screw cap, and trimethylolpropane polyglycidyl ether (Denacol EX 321, manufactured by Nagase ChemteX Corporation, molecular weight: 302, epoxy equivalent: 139, water solubility: 27%) as a crosslinking agent having three epoxy groups in one molecule is added such that the crosslinking rate becomes the crosslinking rate listed in Table 1. The glass bottle is tightly stopped, and the mixture is heated at 70 °C for 5 hours while being stirred with a stirrer. After a lapse of 5 hours, the temperature is lowered to room temperature, and filtration is performed with a 25-ml capacity needleless syringe (manufactured by Terumo Corporation) equipped with a 5-μm filter (acetylcellulose membrane, outer diameter: 2.5 cm, manufactured by FUJIFILM Corporation) to obtain a crosslinked resin-dispersed pigment. The crosslinking rate is adjusted by the parts by mass of the crosslinking agent to be added.

### 1.2. Preparation of Non-Crosslinked Resin-Dispersed Pigment

A non-crosslinked resin-dispersed pigment was prepared in the same manner as for the above crosslinked resin-dispersed pigment, except that the step of “Crosslinking of Resin” was not performed.

### 1.3. Preparation of Binder Resin

### Preparation of Binder Resin 1

A reaction vessel equipped with a stirrer, a reflux condenser, a dropping device, and a thermometer is charged with 900 g of ion exchanged water and 3 g of sodium lauryl sulfate, and the mixture is heated to 70 °C while being stirred and purged with nitrogen. While the internal temperature is maintained at 70 °C, 4 g of potassium persulfate as a polymerization initiator is added and dissolved, and then an emulsion prepared in advance by adding 20 g of acrylamide, 300 g of styrene, 640 g of butyl acrylate, and 30 g of methacrylic acid to 450 g of ion exchanged water and 3 g of sodium lauryl sulfate with stirring is continuously added dropwise into the reaction solution over 4 hours. After the end of dropwise addition, the mixture is aged for 3 hours. After cooling the obtained aqueous emulsion to room temperature, ion exchanged water and a 5% aqueous sodium hydroxide solution are added to adjust the solid content to 40 wt % and pH to 8, obtaining a binder resin 1 as an emulsion of an acrylic-based resin.

### Preparation of Binder Resin 2

A four-necked flask equipped with a stirrer, a thermometer, a nitrogen gas introduction tube, and a reflux tube is prepared. This four-necked flask is charged with 41.7 parts by weight of isophorone diisocyanate, 40.1 parts by weight of polypropylene glycol (number average molecular weight: 2,000), 13.2 parts by weight of dimethylolpropionic acid, and 200.0 parts by weight of methyl ethyl ketone, which are reacted at 80 °C for 6 hours in a nitrogen gas atmosphere (a primary reaction). Then, 0.6 part by weight of ethylenediamine, 2.0 parts by weight of methanol, 2.4 parts by weight of dimethylolpropionic acid, and 100.0 parts by weight of methyl ethyl ketone are added. The residual rate of isocyanate groups is determined by FT-IR, and the mixture is reacted at 80 °C until a desired residual rate is achieved (a secondary reaction) to obtain a reaction solution. The obtained reaction solution is cooled to 40 °C, ion exchanged water is added, and an aqueous potassium hydroxide solution is added while stirring at a high speed with a homo-mixer. Methyl ethyl ketone is distilled off from the obtained liquid by heating under reduced pressure to obtain a liquid containing a binder resin 2, which is a water-soluble urethane-based resin (acid value: 65 mgKOH/g, weight average molecular weight: about 21,000).

### 2. Evaluation

2.1. Storage stability

### 2.1.1. Foreign Matter Occurrence Inhibition Properties

The ink in an amount of 500 g is sealed in an ink pack and left to stand in an environment of 70 °C for 2 weeks. For the ink after being left to stand, the amount of liquid passed when a liquid passing test is performed with one 10-μm membrane filter is observed. Since the amount of liquid passed changes in accordance with the amount of foreign matter occurring, it can be used for the determination of foreign matter.

### Evaluation Criteria

A: The whole amount is passed.
B: The amount of liquid passed is 70% or more and less than 100%.
C: The amount of liquid passed is less than 70% and 50% or more.
D: The amount of liquid passed is less than 50%.

### 2.1.2. Dissolution Stability

An aqueous ink solution excluding the pigment, the resin dispersant, and the binder resin is prepared, and the dissolution state of the ink after being left to stand for 24 hours at 60 °C and 50 °C each is checked. Note that it is confirmed that the aqueous ink solution is transparent (completely dissolved) at 20 °C.

### Evaluation Criteria

A: Neither phase separation nor cloudiness occurred both at 50 °C and 60 °C.
B: Neither phase separation nor cloudiness occurred at 50 °C, but phase separation or cloudiness occurred at 60 °C.
C: Phase separation or cloudiness occurred both at 50 °C and 60 °C.

### 2.2. Defoaming Properties

The ink in an amount of 10 ml is put into a 110-ml glass bottle, which is shaken up and down 20 times, and the time until the occurring foam disappears is measured.
A: The foam disappeared in 1 minute or less.
B: The foam disappeared in greater than 1 minute and 5 minutes or less.
C: The foam does not disappear even in greater than 5 minutes.

### 2.3. Image Quality

A printer (modified machine manufactured by Seiko Epson Corporation) is filled with the ink, and after confirming that all nozzles can eject the ink, a solid pattern is recorded on plain paper (V-paper, A4 size, manufactured by FUJIFILM Corporation) on one pass at a recording resolution of 360 dpi×360 dpi, and the presence or absence of white streaks on the printed matter is visually checked. Note that the white streak is a printing failure caused by insufficient wetting and spreading of dots, and is influenced by the wetting and spreading properties and the permeability of the ink.
A: No white streaks are observed.
B: White streaks are slightly observed.
C: White streaks are considerably observed.

### 2.4. Biomass Degree

The biomass degree of the dry solid content of the ink composition is calculated by the above-described method on the basis of the dry solid content of the ink composition, that is, the pigment, and in the case of the dispersant-dispersed pigment, the composition of its dispersant.

### 3. Evaluation Results

It is found from the evaluation results of Tables 1 and 2 that all of Examples 1 to 30 according to the present embodiment have more excellent storage stability and defoaming properties than Comparative Examples 1 to 5. It is found from Reference Example 1 that when a non-zwitterionic compound is used as a dispersion aid, the foreign matter occurrence inhibition properties are good, but the dissolution stability and defoaming properties are poor.

What is claimed is:

1. An ink jet ink composition comprising:
a pigment; and
a zwitterionic compound, wherein
the pigment includes a resin-dispersed pigment dispersed by a crosslinked resin, and
the ink jet ink composition is a water-based ink.

2. The ink jet ink composition according to claim 1, wherein the pigment includes an organic pigment and/or a carbon black.

3. The ink jet ink composition according to claim 1, wherein the resin is a resin crosslinked by a compound having two or more functional groups of one or more kinds selected from the group consisting of an epoxy group, an oxazoline group, and an isocyanate group in a molecule.

4. The ink jet ink composition according to claim 1, wherein a mass ratio of the resin to the pigment is 0.1 to 0.7.

5. The ink jet ink composition according to claim 1, wherein the zwitterionic compound includes one or more selected from the group consisting of an amino acid, sulfamic acid, a betaine, phosphatidylcholine, and psilocybin.

6. The ink jet ink composition according to claim 1, wherein the zwitterionic compound includes trimethylglycine.

7. The ink jet ink composition according to claim 1, comprising an organic solvent A having an octanol-water partition coefficient logP_{ow} of 0 to 1.

8. The ink jet ink composition according to claim 1, wherein a biomass degree of a dry solid content of the ink jet ink composition is 10% or more.

9. The ink jet ink composition according to claim 1, wherein the pigment includes a biological oil-derived carbon black.

10. A recording method comprising an ejecting step of ejecting the ink jet ink composition according to claim 1 onto a recording medium by an ink jet method.
